(19) United States
(12) Patent Application Publication
(10) Pub. No.: US 2015/0213105 A1
(43) Pub. Date: Jul. 30, 2015

(54) DATA PROCESSING METHOD, APPARATUS, AND STORAGE MEDIUM

(71) Applicant: Tencent Technology (Shenzhen) Company Limited, Shenzhen Guangdong (CN)

(72) Inventor: Hua FAN, Shenzhen Guangdong (CN)

(73) Assignee: Tencent Technology (Shenzhen) Company Limited, Shenzhen Guangdong (CN)

(21) Appl. No.: 14/682,776

(22) Filed: Apr. 9, 2015

Related U.S. Application Data
(63) Continuation of application No. PCT/CN2013/084205, filed on Sep. 25, 2013.

(30) Foreign Application Priority Data
Oct. 11, 2012 (CN) 201210384703.X

(51) Int. Cl. G06F 17/30

(52) U.S. Cl. CPC G06F 17/30581; G06F 17/30312; G06F 2201/835

(57) ABSTRACT

A data updating request and a data processing request may be synchronously received. The data updating request may replace to-be-deleted data with to-be-written data, while the data processing request may operate using the to-be-deleted data. The solutions described throughout the present document facilitate execution of the two conflicting requests in parallel, substantially simultaneously, and synchronously, for example on respective threads. To facilitate the execution of the two requests, the to-be-written data may be stored to a first storage space, the to-be-deleted data may be stored to a second storage space, and the to-be-deleted data in the second storage space may be released if execution of the data processing request that meets a releasing condition is completed. The respective threads may synchronize with each other by postponing the release of memory. Thus, the two requests may execute synchronously and substantially simultaneously and consequently improving processing efficiency without occupying significant memory space.

### CROSS-REFERENCE TO RELATED APPLICATION

This application is a continuation of International Application No. PCT/CN2013/084205, filed on Sep. 25, 2013, which claims priority to Chinese Patent Application No. 201210384703.X, filed on Oct. 11, 2012, both of which are hereby incorporated by reference in their entireties.

### FIELD OF THE TECHNOLOGY

The present disclosure relates to the field of data processing technologies, and in particular, to a data processing method, apparatus, and a storage medium.

### BACKGROUND OF THE DISCLOSURE

In-memory indexing is widely applied to information retrieval systems that require real-time updating such as for an advertisement playback searching system, or a real-time searching system. To improve service concurrency performance, the in-memory indexing may execute in a multi-core and multithread environment. In such an environment, one updating thread may update the index while multiple processing threads, such as read or write threads, may access the index at the same time.

Conventionally, the following indexing types are used.

Blocking-type synchronized indexing: In this case, when a read thread or a write thread is accessing an index, the thread locks a shared data. Therefore, other read threads or write threads cannot access the resource and are blocked until the thread releases the lock. Problems such as deadlock, livelock, priority inversion, and low efficiency, are prone to happen in this manner.

Lock-free structure indexing: In this case, in view of atomicity of pointer switch, two memory buffers, namely, a read buffer and a write buffer, are maintained in memory, and a pointer is used to indicate whether the read buffer or the write buffer is currently executed. For example, after an updating thread finishes updating the write buffer, the updating thread switches to the read buffer for read and write. In this manner, because double buffers are used, there is waste for the memory; besides, because index data itself occupies a large amount of memory, memory occupation doubles if double buffers are used.

In conclusion, there is need to resolve the technical problem in the conventional technology that when an updating thread is synchronous with a read/write thread, large memory space is occupied and the processing efficiency is low.

### SUMMARY

One objective of the present disclosure is to provide a data processing method, which aims to solve a technical problem in the conventional technology that when an updating thread is synchronous with a read/write thread, large memory space is occupied and the processing efficiency is low.

To solve the foregoing technical problem, the present disclosure proposes a data processing method that includes the following steps. The method may include configuring, by a processor, a memory indexing scheme. The memory indexing may include a first index space and a second index space. The first index space may store a pointer to to-be-written data, and the second index space may store an index of to-be-deleted data. The data processing method may also include receiving, by the processor, a data updating request and a data processing request synchronously. The data updating request may include an instruction to replace the to-be-deleted data with the to-be-written data, and the data processing request may include an instruction to perform corresponding processing on the to-be-deleted data. The method may include synchronously executing, by the processor, the data updating request and the data processing request. For the simultaneous execution, the data processing method may also include storing the to-be-written data to a first storage space and replacing, in the memory indexing, a pointer to the to-be-deleted data with the pointer to the to-be-written data. The data processing method may also include storing the to-be-deleted data to a second storage space. The method may include determining whether the execution of the data processing request that meets a releasing condition is completed. The method may include releasing the to-be-deleted data in the second storage space in response to the release condition being met by the execution of the data processing request.

Another objective of the present disclosure is to provide a data processing method, to solve the technical problem in the conventional technology that when an updating thread is synchronous with a read/write thread, large memory space is occupied and the processing efficiency is low.

Accordingly, the present document describes a data processing method that includes the following steps. The data processing method may include receiving a data updating request and a data processing request synchronously. The data updating request may include an instruction to replace a first data with a second data, and the data processing request may include an instruction to perform processing on the first data. The data processing method may also include storing the second data to a first storage space. The data processing method may also include storing the first data to a second storage space. The data processing method may also include synchronously executing the data updating request and the data processing request on respective threads. The data processing method may also include determining whether execution of the data processing request that meets a releasing condition is completed. The data processing method may also include releasing the first data from the second storage space in response to the execution of the data processing request that meets the releasing condition is completed.

In another aspect a data processing apparatus is described. The apparatus solves the technical problem in the conventional technology that when an updating thread is synchronous with a read/write thread, large memory space is occupied and the processing efficiency is low.

The data processing apparatus may include a request receiving module configured to receive a data updating request and a data processing request synchronously. The data updating request is to replace to-be-deleted data with to-be-written data, and the data processing request is to perform processing on the to-be-deleted data. The data processing apparatus may also include a data storing module configured to store the to-be-written data to a first storage space and store the to-be-deleted data to a second storage space. The data processing apparatus may also include a determining module configured to determine whether execution of the data processing request meets a releasing condition. The data processing apparatus may also include a data releasing module configured to release the to-be-deleted data in the second storage space in response to the releasing condition being met by the execution of the data processing request.

Yet another objective of the present disclosure is to describe a non-transitory storage medium, the storage medium storing processor executable instructions, and the processor executable instructions enabling a processor to perform the operations. The non-transitory storage medium may include instructions to receive a data updating request and a data processing request synchronously. The data updating request is to replace to-be-deleted data with to-be-written data, and the data processing request is to perform corresponding processing on the to-be-deleted data. The non-transitory storage medium may also include instructions to substantially simultaneously execute the data updating request and the data processing request on respective threads. The non-transitory storage medium may also include instructions to store the to-be-written data to a first storage space. The non-transitory storage medium may also include instructions to store the to-be-deleted data to a second storage space. The non-transitory storage medium may also include instructions to determine whether execution of the data processing request that meets a releasing condition is completed. The non-transitory storage medium may also include instructions to release the to-be-deleted data in the second storage space if the execution of the data processing request that meets the releasing condition is completed.

The technical solutions described by the examples throughout the present document may include synchronizing an updating thread and a read/write thread by postponing the release of to-be-deleted data. For example, when a data updating request and a data processing request are simultaneously received, a first storage unit may be allocated to store the to-be-written data, while the to-be-deleted data may be stored to a second storage unit. The to-be-deleted data in the second storage unit may not be released until execution of each data processing request that meets a releasing condition is completed. The technical solutions describe do not use locking, occupy little memory, and have high processing efficiency.

### BRIEF DESCRIPTION OF THE DRAWINGS

The example embodiments described throughout the present disclosure may be better understood with reference to the following drawings and description. The components in the drawings are not necessarily to scale. Moreover, in the drawings, like-referenced numerals designate corresponding parts throughout the different views.

FIG. 1 is a schematic diagram of an example environment for execution of a data processing method;

FIG. 2 is a schematic flowchart of a data processing method according to a first example;

FIG. 3 is a schematic flowchart of a data processing method according to a second example;

FIG. 4 is a schematic structural diagram of memory indexing according to an example; and

FIG. 5 is a schematic structural diagram of a data processing apparatus according to an example.

### DESCRIPTION OF EMBODIMENTS

The technical solutions described throughout the present disclosure may improve operation of devices such as (but not limited to) a handheld telephone, a personal computer, a server, a multiprocessor system, a system operated by a microcomputer, a main-frame architecture-type computer, and a distributed operation environment including any one of the foregoing systems or apparatuses.

The term “module” used in this specification may be hardware or a combination of hardware and software. For example, each module may include an application specific integrated circuit (ASIC), a Field Programmable Gate Array (FPGA), a circuit, a digital logic circuit, an analog circuit, a combination of discrete circuits, gates, or any other type of hardware or combination thereof. Alternatively or in addition, each module may include memory hardware, such as a portion of memory, for example, that comprises instructions executable with a processor to implement one or more of the features of the module. When any one of the module includes the portion of the memory that comprises instructions executable with the processor, the module may or may not include the processor. In some examples, each module may just be the portion of the memory or other physical memory that comprises instructions executable with the processor to implement the features of the corresponding module without the module including any other hardware. Because each module includes at least some hardware even when the included hardware comprises software, each module may be interchangeably referred to as a hardware module.

FIG. 1 is a schematic diagram of an example environment for execution of a data processing method. The data processing method may be implemented in a terminal 10. The terminal 10 may include a processor 11 and a memory 12. The data processing method may be implemented by the processor 11. For example, the processor 11 may control operations on data such as by writing to the memory and deleting from the memory. The processor may identify portion of the data in the memory that is to be deleted, which referred to as “to-be-deleted data” in the present disclosure. The processor may identify data that is to be written to the memory, which is referred to as “to-be-written data” throughout the present disclosure.

The terminal 10 may be a desk computer, or any other type of terminal that has a storage unit and a processor. Other examples of a terminal may include a notebook computer, a workstation, a palmtop computer, an ultra-mobile personal computer (UMPC), a tablet PC, a personal digital assistant (PDA), a web pad, or a portable telephone.

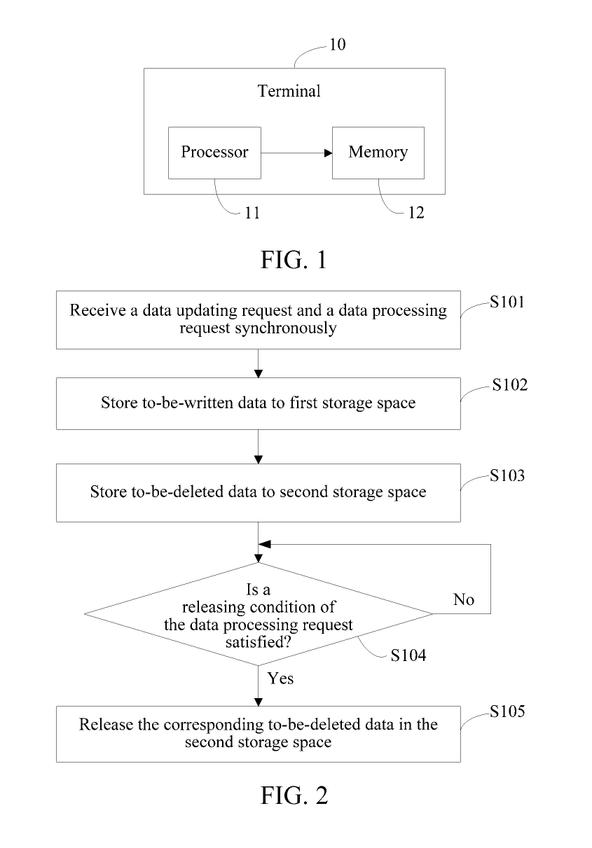

FIG. 2 is a schematic flowchart of a data processing method according to a first example.

In Step S101, the processor 11 may receive a data updating request and a data processing request synchronously. The processor may execute the data updating request and the data processing request on individual thread. In an example, multiple data processing requests may be received. Each data processing request may be executed on a respective thread. For simplicity of explanation, unless explicitly described, the examples describe receiving two requests—a data updating request and a data processing request. However, it will be understood that the examples may include receiving multiple data processing request substantially simultaneously with the data updating request.

The data updating request is used to replace to-be-deleted data with to-be-written data, and the data processing request is used to perform corresponding processing on the to-be-deleted data. The processor may initiate execution of operations according to the data processing request and the data updating request concurrently.

‘Synchronously’ refers to the processor receiving the two requests substantially simultaneously. Alternatively or in addition, ‘synchronously’ refers to receiving a first of the two requests and before the processor 11 begins operation associated with the first request, receiving the second request. For example, the processor 11 may receive the data updating request first and before the processor 11 may start replacing data as per that request, the processor 11 may receive the data processing request as the second request. In another example, the data processing request may be received first and the data updating request may be received second. In other words, a time duration between receipt of the two requests may be shorter than a time duration for the processor 11 to begin working on one of the two received requests. In another example, the time duration between receipt of the two requests may be shorter than a time duration for the processor 11 to complete working on one of the two received requests.

In Step S102, the processor 11 may store the to-be-written data to first storage space in the memory 12. For example, the processor 11 may store the to-be-written data in response to the data updating request.

In this step, during data updating, the processor 11 may initially request allocation of the first storage space. The processor 11 may subsequently, and in response, write the to-be-written data to the first storage space.

In Step S103, the processor 11 may store the to-be-deleted data to a second storage space in the memory 12. The processor 11 may request allocation of the second storage space. Alternatively, the second storage space may be a predetermined storage space in the memory 12.

In Step S104, the processor 11 may determine whether execution of the data processing request satisfies a releasing condition associated with the data processing request; if yes, the processor may proceed to step S105; otherwise, the processor may continue to perform step S104 until the release condition is satisfied.

In Step S105, the processor 11 may release the to-be-deleted data in the second storage space in the memory 12. Releasing the to-be-deleted data may include clearing the reference of the to-be-deleted data from the second storage space.

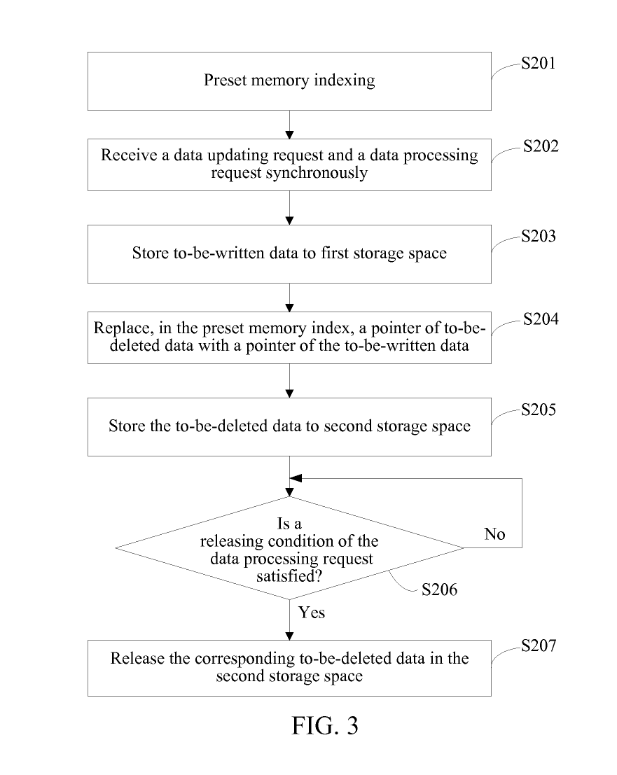

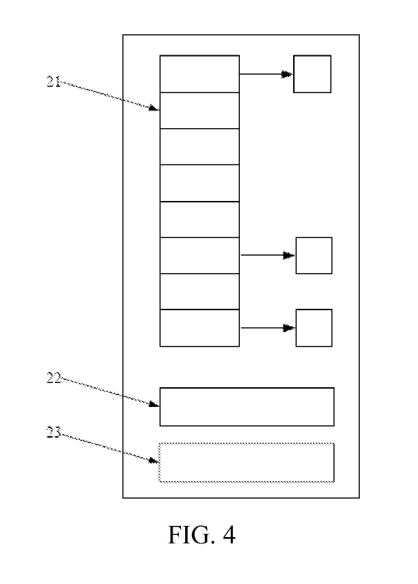

FIG. 3 is a schematic flowchart of a data processing method according to a second example.

In Step S201, the processor 11 may preset a memory indexing scheme for the memory 12.

For example, FIG. 4 is a schematic structural diagram of memory indexing according to an example scheme. The memory indexing may include a first index space 21, a second index space 22, and a third index space 23.

The first index space 21 may store a pointer to the to-be-written data. The second index space 22 may store an index of the to-be-deleted data. Each entry in the index of the to-be-deleted data may include a data memory pointer and a time identification. The data memory pointer may refer to an address of a memory location at which the data to be processed is stored. The time identification may indicate time when the index of the to-be-deleted data was added to the second index space 22. The third index space 23 may store a time identification of the data updating request that is currently active, which may also be referred to as a current data updating request.

In Step S202, the processor 11 may receive a next data updating request and a data processing request synchronously.

The next data updating request may instruct the processor 11 to replace the to-be-deleted data with the to-be-written data. The data processing request may instruct the processor 11 to perform corresponding processing on the to-be-deleted data. For example, processing may include reading the to-be-deleted data. Alternatively or in addition, the processing may include writing to the memory location referred to by the data memory pointer of an entry in the index of the to-be-deleted data. Since, the data updating request and the data processing request are synchronously received in step S202, the processor may execute the two operations synchronously. However, synchronous execution of the two requests without the solutions described throughout the present disclosure may cause incorrect operations. For example, the next data updating request may change the data that is being referred to by the to-be-deleted data, and thus the data processing request may operate on data different than what was intended. The following steps may prevent such misappropriation of data and still allow the processor 11 to synchronously execute the two requests, the next data updating request and the data processing request.

In Step S203, the processor 11 may store the to-be-written data to the first storage space in the memory 12.

In this step, during data updating, the processor 11 may initially request allocation of the first storage space. The processor 11 may subsequently store the to-be-written data to the first storage space. The to-be-written data may include data to be operated upon. Alternatively or in addition, the to-be-written data may include pointers to the data that is to be operated upon.

In Step S204, the processor 11 may replace, in the preset memory indexing, a pointer to the to-be-deleted data with a pointer to the to-be-written data. A pointer to the to-be-written data is an address of a memory location at which the to-be-written data is stored.

In Step S205, the processor 11 may store the to-be-deleted data to the second storage space in the memory 12.

In an example, the index of the to-be-deleted data may be written to the second index space 22, such that each entry in the index is stored to the second storage space at substantially the same time. For example, the index may be stored in a single memory operation. A current time identification (for example, a timestamp) may be recorded in the entries of the index of the to-be-deleted data.

In Step S206, the processor 11 may determine whether execution of the data processing request meets a releasing condition. If yes, the processor may proceed to step S207. Otherwise, the processor 11 may continue to perform step S206 until the releasing condition is met. The releasing condition may confirm that the next data processing request is completed operations based on the data updated by the data updating request.

For example, the releasing condition may be determined based on the timing of the data updating request and the data processing request. In an example, the processor 11 may record a first time identification corresponding to receipt of the data processing request. In case multiple data processing requests are received, the processor 11 may record a first time identification for each respective data processing request. The processor may record a second time identification indicating time when the to-be-deleted data is stored to the second storage space. The processor may compare the first time identifications and the second time identification. Based on the comparison, the processor may determine whether the second time identification indicates a time prior to that of each first time identification. If the second time identification indicates a time prior to that of each first time identification and execution of the data processing request corresponding to the first time identification is completed, the processor 11 may deem that the releasing condition of the data processing request is met or satisfied. Accordingly, the processor 11 may release the to-be-deleted data corresponding to the data processing request.

In addition, there may be another releasing condition. For example, a time identification indicating an earliest time of entering a retrieval request is acquired from the third index space 23. The to-be-deleted data prior the time indicated by the time identification of the retrieval request may be all recycled.

In Step S207, the processor 11 may release the corresponding to-be-deleted data in the second storage space in the memory 12.

In an example, the data processing method provided in the present disclosure may further include a retrieval step. The retrieval request may include sending a retrieval request to the third index space 23 for registration, where registration time includes a time identification (timestamp) of the retrieval request. After execution of the retrieval request is completed, the retrieval request in the third index space 23 may be unregistered.

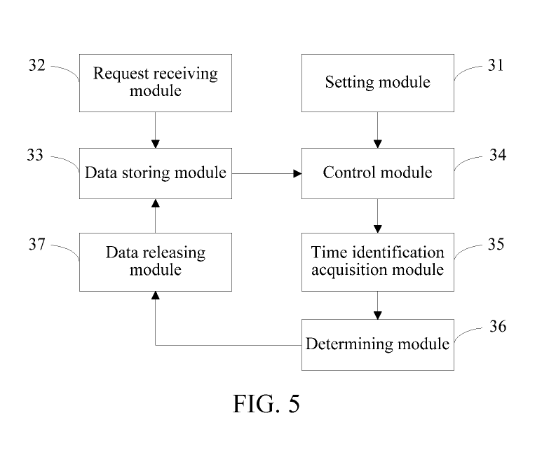

FIG. 5 is a schematic structural diagram of a data processing apparatus according to an example. The apparatus may include a setting module 31, a request receiving module 32, a data storing module 33, a control module 34, a time identification acquisition module 35, a determining module 36, and a data releasing module 37.

The setting module 31 may select and configure a memory indexing scheme. For example, the setting module 31 may select and configure a memory indexing scheme such as the one illustrated in FIG. 4.

The request receiving module 32 may receive a data updating request and a data processing request synchronously. The data updating request may replace the to-be-deleted data with the to-be-written data, and the data processing request may perform corresponding processing on the to-be-deleted data.

The data storing module 33 may store the to-be-written data to first storage space and store the to-be-deleted data to second storage space. The control module 34 may replace, in the first index space 21 in the memory indexing, a pointer to the to-be-deleted data with the pointer to the to-be-written data, and store the index of the to-be-deleted data to the second index space 22.

The time identification acquisition module 35 may monitor and record a first time identification corresponding to when the data processing request is received. In addition, the time identification acquisition module 35 may monitor and record a second time identification when the pointer to the to-be-deleted data in the first index space 21 in the memory indexing is replaced with the pointer to the to-be-written data.

The determining module 36 may determine whether execution of the data processing request meets a releasing condition. For example, if the second time identification indicates a time prior to that of the first time identification and if execution of the data processing request corresponding to the first time identification is completed, the determining module 36 may determine that the execution of the releasing condition is met. In this case, in response, the data releasing module 37 may release the to-be-deleted data from the second storage space.

The data processing apparatus described may be part of a terminal. For example, the terminal may be a computer, a tablet computer, a mobile phone with a touch function, a notebook computer, or the like. The example methods described throughout the present disclosure may be implemented by the data processing apparatus.

The example methods and apparatus described throughout the present disclosure, provide technical solutions to the technical problems of synchronization between an updating thread and processing thread. The updating thread may perform operations that are part of the data updating request that may include releasing to-be-deleted data. The processing thread may perform operations such as read/write that are part of the data processing request. For example, the example methods and apparatus may postpone the release of the to-be-deleted data. In other words, when a data updating request and a data processing request are received substantially simultaneously for execution by separate threads substantially simultaneously and in a synchronous manner, a first storage unit may be first allocated to store the to-be-written data, and the to-be-deleted data may be stored to a second storage unit. The to-be-deleted data in the second storage unit may not be released until execution of each data processing request that meets a releasing condition is completed. The whole process requires no locking, occupies little memory, and has high processing efficiency.

All or a part of the procedures of the data processing methods of the present disclosure may be implemented by a computer program controlling relevant hardware. The computer program may be stored in a computer readable storage medium. For example, the computer program may be stored in a storage of a terminal and executed by at least one processor in the terminal. The procedures of the data processing methods described throughout the present document may be included in an execution process. The storage medium may be a magnetic disk, an optical disc, a read-only memory (ROM), a random access memory (RAM), a hard disk, a floppy disk, a CD-ROM, a flash drive, a cache, volatile memory, non-volatile memory, RAM, flash memory, or any other type of non-transitory computer readable storage medium or storage media. However, the computer readable storage medium is not a transitory transmission medium for propagating signals.

Functional modules of the data processing apparatus in this embodiment of the present disclosure may be integrated into one processing chip, or each of the modules may independently exist physically, or two or more modules may be integrated into one module. The integrated module may be implemented in a form of hardware, or may be implemented in a form of a software functional module. If the integrated module is implemented in a form of a software functional module and sold or used as an independent product, the integrated module may also be stored in a non-transitory computer-readable storage medium such as those listed above.

The respective logic, software or instructions for implementing the processes, methods and/or techniques discussed above may be provided on computer readable storage media. The functions, acts or tasks illustrated in the figures or described herein may be executed in response to one or more sets of logic or instructions stored in or on computer readable media. The functions, acts or tasks are independent of the particular type of instructions set, storage media, processor or processing strategy and may be performed by software, hardware, integrated circuits, firmware, micro code and the like, operating alone or in combination. Likewise, processing strategies may include multiprocessing, multitasking, parallel processing and the like. In one embodiment, the instructions are stored on a removable media device for reading by local or remote systems. In other embodiments, the logic or instructions are stored in a remote location for transfer through a computer network or over telephone lines. In yet other embodiments, the logic or instructions are stored within a given computer, central processing unit (“CPU”), graphics processing unit (“GPU”), or system.

Furthermore, although specific components are described above, methods, systems, and articles of manufacture described herein may include additional, fewer, or different components. For example, a processor may be implemented as a microprocessor, microcontroller, application specific integrated circuit (ASIC), discrete logic, or a combination of other type of circuits or logic. Similarly, memories may be DRAM, SRAM, Flash or any other type of memory. Flags, data, databases, tables, entities, and other data structures may be separately stored and managed, may be incorporated into a single memory or database, may be distributed, or may be logically and physically organized in many different ways. The components may operate independently or be part of a same program or apparatus. The components may be resident on separate hardware, such as separate removable circuit boards, or share common hardware, such as a same memory and processor for implementing instructions from the memory. Programs may be parts of a single program, separate programs, or distributed across several memories and processors.

A second action may be said to be “in response to” a first action independent of whether the second action results directly or indirectly from the first action. The second action may occur at a substantially later time than the first action and still be in response to the first action. Similarly, the second action may be said to be in response to the first action even if intervening actions take place between the first action and the second action, and even if one or more of the intervening actions directly cause the second action to be performed. For example, a second action may be in response to a first action if the first action sets a flag and a third action later initiates the second action whenever the flag is set.

To clarify the use of and to hereby provide notice to the public, the phrases “at least one of <A>, <B>, . . . and <N>” or “at least one of <A>, <B>, . . . <N>, or combinations thereof” or “<A>, <B>, . . . and/or <N>” are to be construed in the broadest sense, superseding any other implied definitions hereinbefore or hereinafter unless expressly asserted to the contrary, to mean one or more elements selected from the group comprising A, B, . . . and N. In other words, the phrases mean any combination of one or more of the elements A, B, . . . or N including any one element alone or the one element in combination with one or more of the other elements which may also include, in combination, additional elements not listed.

While various embodiments have been described, it will be apparent to those of ordinary skill in the art that many more embodiments and implementations are possible. Accordingly, the embodiments described herein are examples, not the only possible embodiments and implementations.

What is claimed is:

1. A data processing method, comprising:
configuring, by a processor, a memory indexing scheme, wherein the memory indexing comprises a first index space and a second index space, the first index space is used to store a pointer to to-be-written data, and the second index space is used to store an index of to-be-deleted data;
receiving, by the processor, a data updating request and a data processing request synchronously, wherein the data updating request comprises an instruction to replace the to-be-deleted data with the to-be-written data, and the data processing request comprises an instruction to perform corresponding processing on the to-be-deleted data; and
synchronously executing, by the processor, the data updating request and the data processing request by:
storing the to-be-written data to a first storage space;
replacing, in the memory indexing, a pointer to the to-be-deleted data with the pointer to the to-be-written data;
storing the to-be-deleted data to a second storage space;
determining whether the execution of the data processing request that meets a releasing condition is completed; and
releasing the to-be-deleted data in the second storage space in response to the release condition being met by the execution of the data processing request.

2. The data processing method according to claim 1, wherein the step of storing the to-be-deleted data to the second storage space comprises:
replacing, in a first index space, the pointer to the to-be-deleted data with the pointer to the to-be-written data; and
storing an index of the to-be-deleted data to a second index space.

3. The data processing method according to claim 2, wherein determining whether the execution of the data processing request that meets the releasing condition is completed further comprises:
recording a first time identification corresponding to receipt of the data processing request;
recording a second time identification corresponding to replacing, in the first index space, the pointer to the to-be-deleted data with the pointer to the to-be-written data; and
comparing the first time identification and the second time identification, and if the second time identification indicates a time prior to the first time identification and if the execution of the data processing request corresponding to the first time identification is completed.

4. The data processing method according to claim 1, wherein the memory indexing further comprises a third index space, and the third index space is used to store a time identification corresponding to receipt of the data updating request that is currently active.

5. A data processing method, comprising:
receiving a data updating request and a data processing request synchronously, wherein the data updating request comprises an instruction to replace a first data with a second data, and the data processing request comprises an instruction to perform processing on the first data;
storing the second data to a first storage space;
storing the first data to a second storage space;
synchronously executing the data updating request and the data processing request on respective threads;
determining whether execution of the data processing request that meets a releasing condition is completed; and
releasing the first data from the second storage space in response to the execution of the data processing request that meets the releasing condition is completed.

6. The data processing method according to claim 5, further comprising:
configuring a memory indexing scheme before receiving the data updating request and the data processing request synchronously, wherein the memory indexing comprises a first index space and a second index space, the first index space is used to store a pointer to the second data, and the second index space is used to store an index of the first data.

7. The data processing method according to claim 6, further comprising:
replacing, in the first index space, a pointer to the first data with the pointer to the second data when storing the first data to the second storage space, and
storing the index of the first data to the second index space.

8. The data processing method according to claim 7, wherein determining whether the execution of the data processing request that meets the releasing condition is completed, further comprises:
recording a first time identification corresponding to receipt of the data processing request;
recording a second time identification when replacing, in the first index space, the pointer to the first data with the pointer to the second data; and
comparing the first time identification and the second time identification, and determining if the second time identification indicates a time prior to that of the first time identification and determining if the execution of the data processing request corresponding to the first time identification is completed.

9. The data processing method according to claim 6, wherein the memory indexing further comprises a third index space, and the third index space is used to store a time identification corresponding to receipt of the data updating request that is currently active.

10. A data processing apparatus, comprising:
a request receiving module configured to receive a data updating request and a data processing request synchronously, wherein the data updating request is to replace to-be-deleted data with to-be-written data, and the data processing request is to perform processing on the to-be-deleted data;
a data storing module configured to store the to-be-written data to a first storage space and store the to-be-deleted data to a second storage space;
a determining module configured to determine whether execution of the data processing request meets a releasing condition; and
a data releasing module configured to release the to-be-deleted data in the second storage space in response to the releasing condition being met by the execution of the data processing request.

11. The data processing apparatus according to claim 10, further comprising:
a setting module, configured to configure a memory indexing, wherein the memory indexing comprises a first index space and a second index space, the first index space is used to store a pointer to the to-be-written data, and the second index space is used to store an index of the to-be-deleted data.

12. The data processing apparatus according to claim 11, further comprising:
a control module, configured to replace, in the first index space, a pointer to the to-be-deleted data with the pointer to the to-be-written data, and store the index of the to-be-deleted data to the second index space.

13. The data processing apparatus according to claim 12, further comprising:
a time identification acquisition module, configured to record a first time identification corresponding to receipt of the data processing request, and record a second time identification corresponding to the pointer to the to-be-deleted data being replaced, in the first index space, with the pointer to the to-be-written data, and, wherein
the data releasing module is further configured to release the to-be-deleted data corresponding to the data processing request in response to
the second time identification being representative of a time prior to that of the first time identification, and
execution of the data processing request corresponding to the first time identification being completed.

14. The data processing apparatus according to claim 11, wherein the memory indexing further comprises a third index space, and the third index space is used to store a time identification corresponding to receipt of the data updating request that is currently active.

15. A non-transitory storage medium storing processor executable instructions, the processor executable instructions enabling a processor to perform operations, the non-transitory storage medium comprising:
instructions to receive a data updating request and a data processing request synchronously, wherein the data updating request is to replace to-be-deleted data with to-be-written data, and the data processing request is to perform corresponding processing on the to-be-deleted data;
instructions to substantially simultaneously execute the data updating request and the data processing request on respective threads;
instructions to store the to-be-written data to a first storage space;
instructions to store the to-be-deleted data to a second storage space;
instructions to determine whether execution of the data processing request that meets a releasing condition is completed; and
instructions to release the to-be-deleted data in the second storage space if the execution of the data processing request that meets the releasing condition is completed.

16. The non-transitory storage medium according to claim 15, further comprising:
instructions to preset memory indexing, to allocate a first index space and a second index space, the first index space is used to store a pointer to the to-be-written data, and the second index space is used to store an index of the to-be-deleted data.

17. The non-transitory storage medium according to claim 16, further comprising:
instructions to replace, in the first index space, a pointer to the to-be-deleted data with the pointer to the to-be-written data when storing the to-be-deleted data to the second storage space, and
instructions to store the index of the to-be-deleted data to the second index space.

18. The non-transitory storage medium according to claim 17, further comprising:
instructions to record a first time identification corresponding to receipt of the data processing request;
instructions to record a second time identification corresponding to replacing, in the first index space, the pointer to the to-be-deleted data with the pointer to the to-be-written data;
instructions to compare the first time identification and the second time identification; and
instructions to release the to-be-deleted data corresponding to the data processing request if the second time identification indicates a time prior to that of the first time identification, and if the execution of the data processing request corresponding to the first time identification is completed.

19. The storage medium according to claim 16, wherein the memory indexing further comprises a third index space, and the third index space is to store a time identification corresponding to receipt of the data updating request that is currently active.
